(19) United States
(12) Patent Application Publication
(10) Pub. No.: US 2026/0022888 A1
(43) Pub. Date: Jan. 22, 2026

(54) FORT’S DRY AND HOLD PAIL

(71) Applicant: Paulette Nicole Briggs, Indpls, IN (US)

(72) Inventor: Paulette Nicole Briggs, Indpls, IN (US)

(21) Appl. No.: 18/780,257

(22) Filed: Jul. 22, 2024

(51) Int. Cl. F26B 25/18

(52) U.S. Cl. CPC F26B 25/185

(57) ABSTRACT

The purpose of the (Fort's Gloves, Dry and Hold Pail) is to prevent moisture that causes the spread of bacteria from restrooms that is the cause of influenza, streptococcus, E coli, Hepatitis, MRSA, Salmonella, Shigella, and Norovirus. The pail is a new creation except for the authentic manuscript and cursive text. There is a distinct difference from the usual and traditional utility pails each community uses, because of the holder for the moisture elimination products that prevents contaminated water from spilling to the floor. Fecal and Trash water could potentially cause mildew growth on the gloves and the pail. The Dry & Hold container overall is a new Invention and a cleaner choice for the environment because the design prevents disease, foul odors.

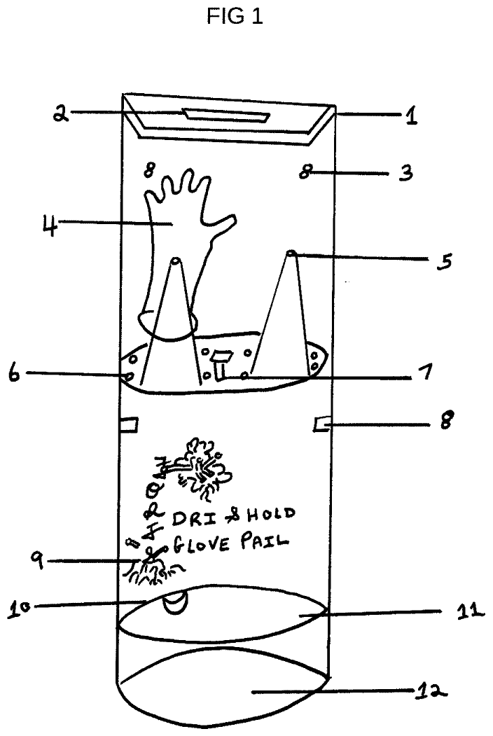

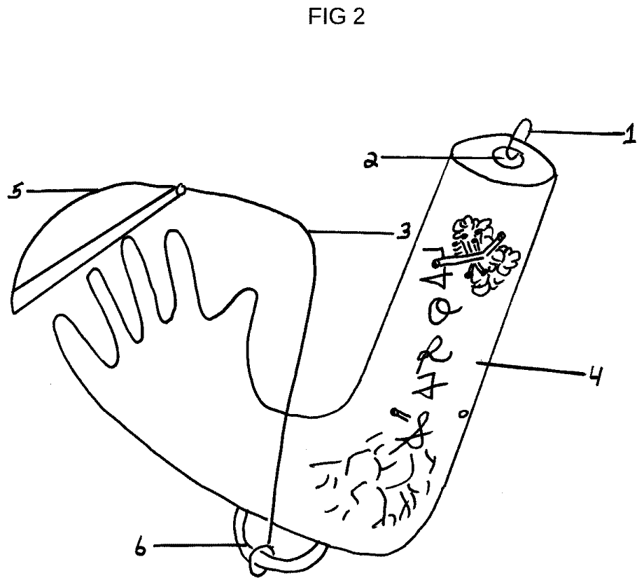

### DETAILED DESCRIPTION

The Fort's Gloves, Dri and Hold Pail invention is created with molds as permitted by law with the process of melting plastics, for example, Latex, and others.

The advantage is the excess contaminated water is less of a contact on the hands, and the surface on and around the container is drier because the cleaning pail has a compartment to use for moisture absorbing products versus the average cleaning gloves and utility pails. The entire container and accessories display an area to separate the spread of bacteria, the encompassing compartment presents a useful space to deplete harmful moisture, odors, and the growth of fungi.

1. The claimed invention (Fort's Dry and Hold Pail) displays compartments to prevent moisture that is a high-risk contamination for example, Staphylococcus Aureus, that could be a health risk in restrooms and utility closets.
